(19) United States
(12) Patent Application Publication
(10) Pub. No.: US 2025/0310909 A1
(43) Pub. Date: Oct. 2, 2025

(54) NETWORK POWER ADAPTATION

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/979,542

(22) Filed: Dec. 12, 2024

Related U.S. Application Data
(60) Provisional application No. 63/571,881, filed on Mar. 29, 2024.
(60) Provisional application No. 63/670,598, filed on Jul. 12, 2024.

(51) Int. Cl. H04W 56/00; H04B 7/06; H04B 17/318

(52) U.S. Cl. CPC H04W 56/0015; H04B 7/06968; H04B 17/328

(57) ABSTRACT

Apparatuses and methods for network power adaptation. A method for a user equipment (UE) to perform a measurement on a cell includes receiving first information for first parameters of a first synchronization signal on the cell and receiving second information for second parameters of a second synchronization signal on the cell. The method further includes receiving the first and second synchronization signals on the cell where the first and second synchronization signals have same quasi co-collocation properties and determining, based on the first and second synchronization signals, the measurement on the cell.

### CROSS-REFERENCE TO RELATED AND CLAIM OF PRIORITY

The present application claims priority under 35 U.S.C. § 119(e) to U.S. Provisional Patent Application No. 63/571,881 filed on Mar. 29, 2024, and U.S. Provisional Patent Application No. 63/670,598 filed on Jul. 12, 2024, which are hereby incorporated by reference in their entirety.

### TECHNICAL FIELD

The present disclosure relates generally to wireless communication systems and, more specifically, the present disclosure is related to apparatuses and methods for network power adaptation.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to network power adaptation.

In one embodiment, a method for a user equipment (UE) to perform a measurement on a cell is provided. The method includes receiving first information for first parameters of a first synchronization signal on the cell and receiving second information for second parameters of a second synchronization signal on the cell. The method further includes receiving the first and second synchronization signals on the cell, wherein the first and second synchronization signals have same quasi co-collocation properties and determining, based on the first and second synchronization signals, the measurement on the cell.

In another embodiment, a UE is provided. The UE includes a transceiver configured to receive first information for first parameters of a first synchronization signal on a cell, second information for second parameters of a second synchronization signal on the cell, and the first and second synchronization signals on the cell. The first and second synchronization signals have same quasi co-collocation properties. The UE further includes a processor operably coupled to the transceiver. The processor is configured to determine, based on the first and second synchronization signals, a measurement on the cell.

In yet another embodiment, a base station is provided. The base station includes a transceiver configured to transmit first information for first parameters of a first synchronization signal on a cell, second information for second parameters of a second synchronization signal on the cell, and the first and second synchronization signals on the cell. The first and second synchronization signals have same quasi co-collocation properties. At most one of the first and second synchronization signals is transmitted at any given time instance.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure according to embodiments of the present disclosure;

FIG. 8 illustrates an example encoding structure for physical downlink control channel (PDCCH) in a subframe according to embodiments of the present disclosure;

FIG. 9 illustrates an example decoding structure for PDCCH in a subframe according to embodiments of the present disclosure;

FIG. 10 illustrates a diagram of example satellite footprints according to embodiments of the present disclosure;

FIG. 11 illustrates an example system for cell coverages according to embodiments of the present disclosure;

FIG. 12 illustrates a flowchart of an example UE procedure for transitioning to a low power consumption state and performing reference signal received power (RSRP) measurements according to embodiments of the present disclosure; and

FIG. 13 illustrates a diagram of example satellite footprints according to embodiments of the present disclosure.

### DETAILED DESCRIPTION

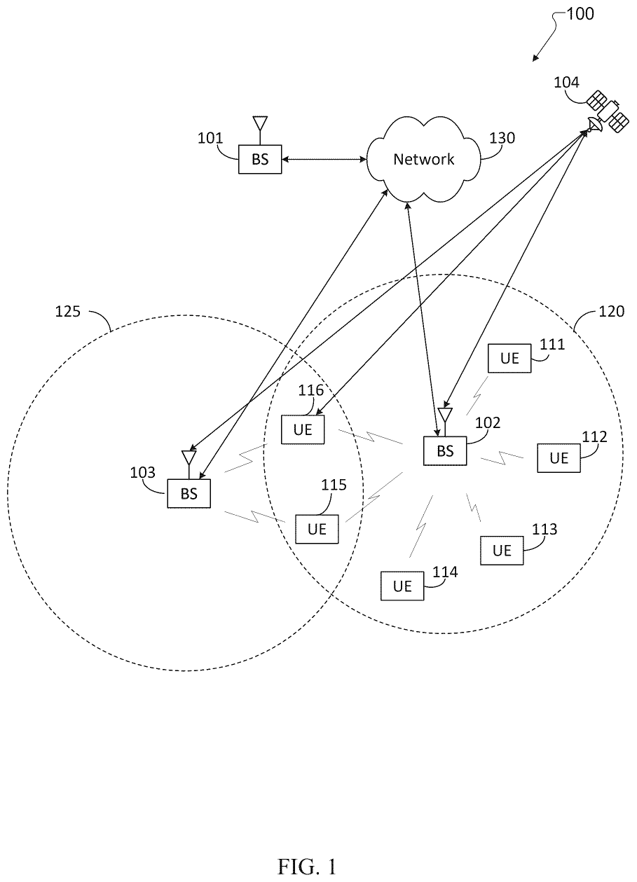

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 v18.1.0, “NR; Physical channels and modulation;” [REF2] 3GPP TS 38.212 v18.1.0, “NR; Multiplexing and channel coding;” [REF3] 3GPP TS 38.213 v18.1.0, “NR; Physical layer procedures for control;” [REF4] 3GPP TS 38.214 v18.1.0, “NR; Physical layer procedures for data;” [REF5] 3GPP TS 38.321 v18.0.0, “NR; Medium Access Control (MAC) Protocol Specification;” and [REF6] 3GPP TS 38.331 v18.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for network power adaptation. In certain embodiments, one or more of the BSs 101-103 include circuitry, programing, or a combination thereof to support network power adaptation.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

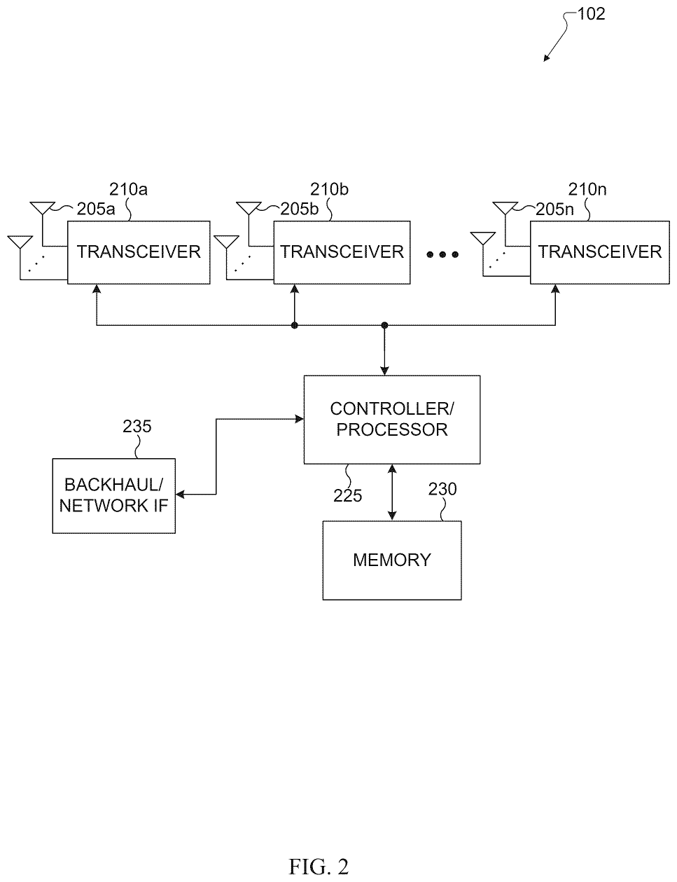

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for network power adaptation. Any of a wide variety of other functions could be supported in the gNB 102 by the controller/processor 225.

The controller/processor 225 is also capable of executing programs and other processes resident in the memory 230, such as processes to trigger network power adaptation. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

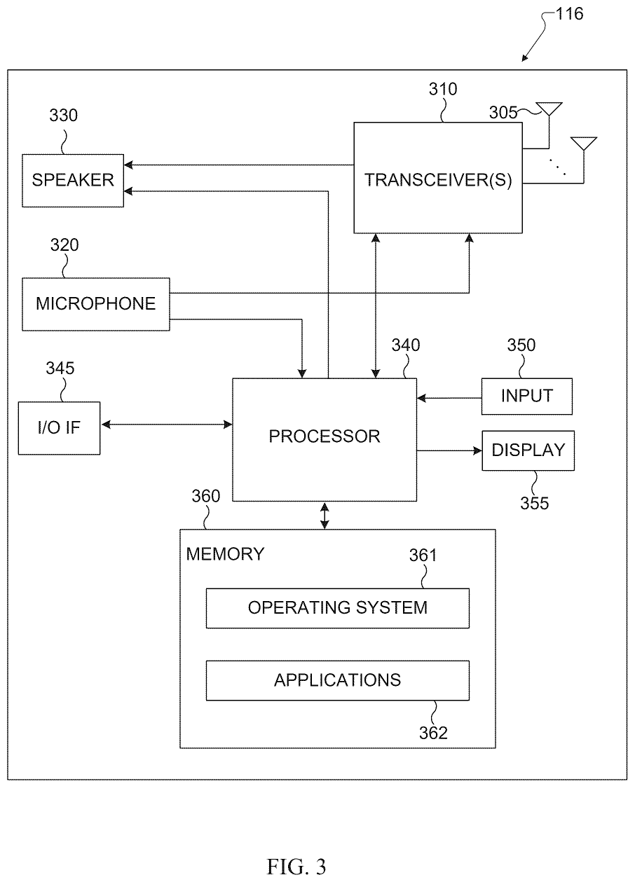

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for network power adaptation as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

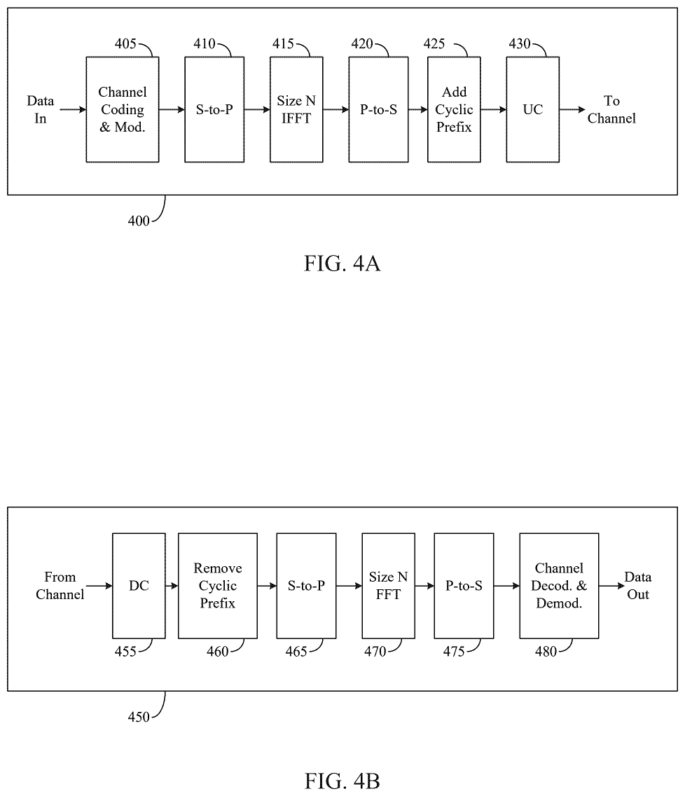

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for utilizing network power adaptation as described in embodiments of the

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

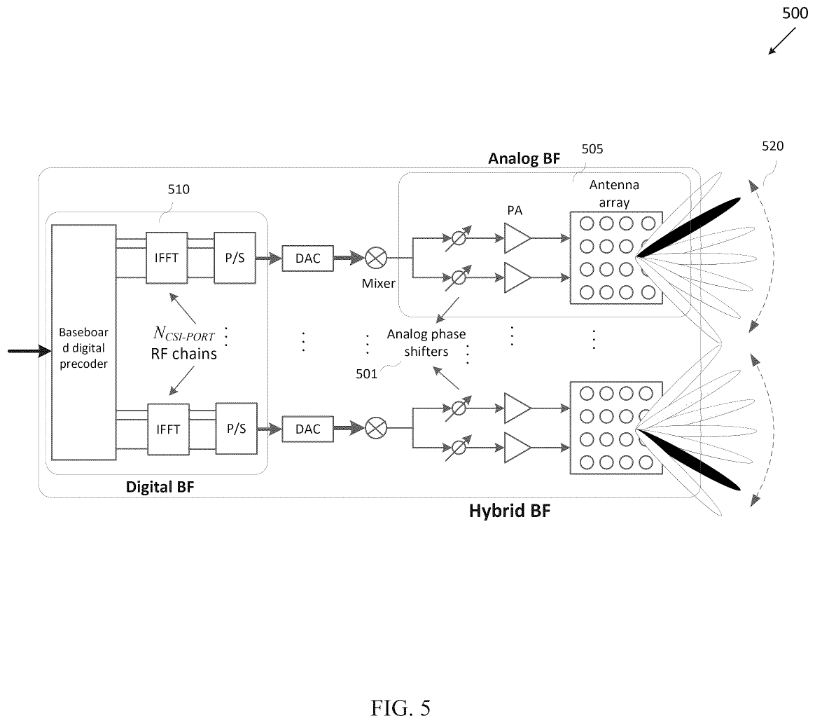

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure. In the following, an italicized name for a parameter implies that the parameter is provided by higher layers.

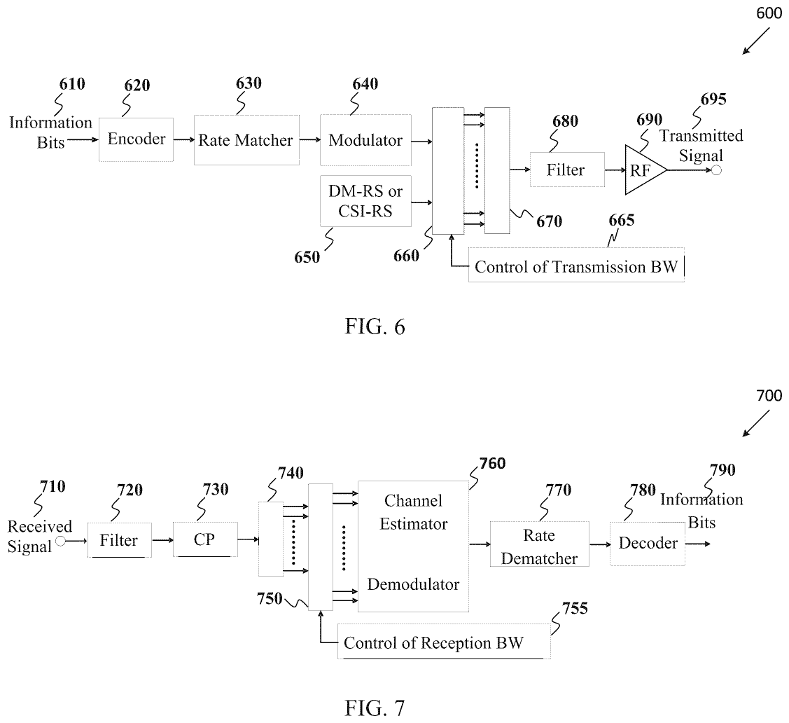

FIG. 6 illustrates an example of a transmitter structure 600 for PDSCH in a subframe according to embodiments of the present disclosure according to embodiments of the present disclosure. For example, transmitter structure 600 can be implemented in gNB 102 of FIG. 1. This example is for illustration only and other embodiments can be used without departing from the scope of the present disclosure.

Information bits, such as downlink control information (DCI) bits or data bits 610, are encoded by encoder 620, rate matched to assigned time/frequency resources by rate matcher 630, and modulated by modulator 640. Subsequently, modulated encoded symbols and demodulation reference signal (DM-RS) or CSI-RS 650 are mapped to REs 660 by RE mapping unit 665, an inverse fast Fourier transform (IFFT) is performed by filter 670, a cyclic prefix (CP) is added by CP insertion unit 680, and a resulting signal is filtered by filter 690 and transmitted by a radio frequency (RF) unit 695.

FIG. 7 illustrates an example of a receiver structure 700 for PDSCH in a subframe according to embodiments of the present disclosure according to embodiments of the present disclosure. For example, receiver structure 700 can be implemented by any of the UEs 111-116 of FIG. 1. This example is for illustration only and other embodiments can be used without departing from the scope of the present disclosure.

A received signal 710 is filtered by filter 720, a CP removal unit removes a CP 730, a filter 740 applies a fast Fourier transform (FFT), RE de-mapping unit 750 de-maps REs selected by bandwidth (BW) selector unit 755, received symbols are demodulated by a channel estimator and a demodulator unit 760, a rate de-matcher 770 restores a rate matching, and a decoder 780 decodes the resulting bits to provide information bits 790.

DL transmissions or UL transmissions can be based on an OFDM waveform including a variant using DFT precoding that is known as DFT-spread-OFDM that is typically applicable to UL transmissions.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 38.211 [REF1] v18.1.0, “NR; Physical channels and modulation”, and 3GPP TS 38.213 v18.1.0 [REF3] “NR; Physical Layer procedures for control”.

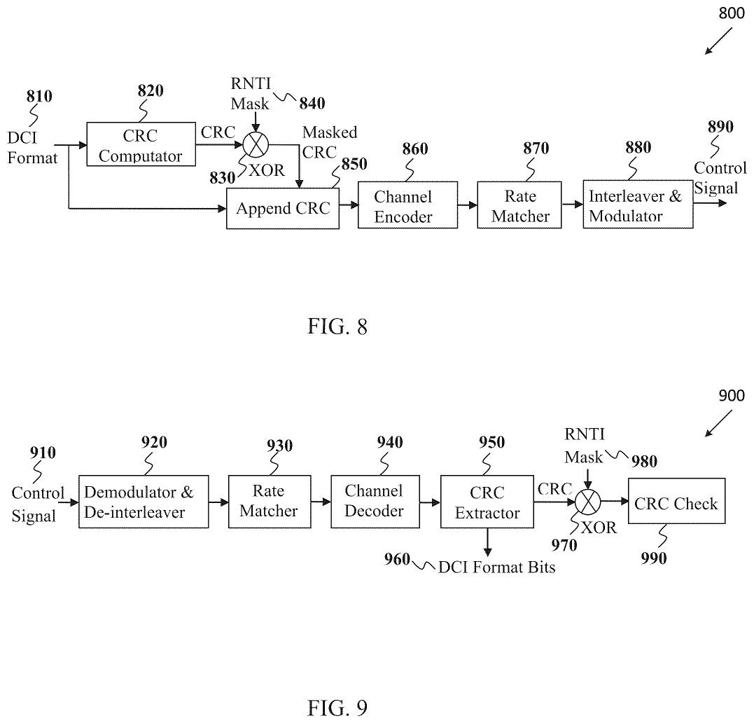

FIG. 8 illustrates an example encoding structure 800 for PDCCH in a subframe according to embodiments of the present disclosure. For example, encoding structure 800 for PDCCH in a subframe can be implemented in gNB 103 of FIG. 1. This example is for illustration only and other embodiments can be used without departing from the scope of the present disclosure.

A gNB (e.g., the gNB 102) separately encodes and transmits each DCI format in a respective PDCCH. When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 810 is determined using a CRC computation unit 820, and the CRC is masked using an exclusive OR (XOR) operation unit 830 between CRC bits and RNTI bits 840. The XOR operation is defined as XOR(0,0)=0, XOR(0,1)=1, XOR(1,0)=1, XOR(1,1)=0. The masked CRC bits are appended to DCI format information bits using a CRC append unit 850. An encoder 860 performs channel coding, such as polar coding, followed by rate matching to allocated resources by rate matcher 870. Interleaving and modulation units 880 apply interleaving and modulation, such as QPSK, and the output control signal 890 is transmitted.

FIG. 9 illustrates an example decoding structure 900 for PDCCH in a subframe according to embodiments of the present disclosure. For example, decoding structure 900 for PDCCH in a subframe can be implemented by any of the UEs 111-116 of FIG. 1. This example is for illustration only and other embodiments can be used without departing from the scope of the

A received control signal 910 is demodulated and de-interleaved by a demodulator and a de-interleaver 920. A rate matching applied at a gNB transmitter is restored by rate matcher 930, and resulting bits are decoded by decoder 940. After decoding, a CRC extractor 950 extracts CRC bits and provides DCI format information bits 960. The DCI format information bits are de-masked 970 by an XOR operation with a RNTI 980 (when applicable) and a CRC check is performed by unit 990. When the CRC check succeeds (check-sum is zero), the DCI format information bits are regarded to be valid. When the CRC check does not succeed, the DCI format information bits are regarded to be invalid.

DCI can serve several purposes. A DCI format includes information elements (IEs) and is typically used for scheduling a PDSCH (DL DCI format) or a physical uplink shared channel (PUSCH) (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with RRC connection to a gNB, the RNTI is a cell RNTI (C-RNTI) or another RNTI type such as a modulation and coding scheme-cell radio network temporary identifier (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access RNTI (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH transmissions.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 v18.0.0 [REF2], or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ)mod kₛ=0. The UE monitors PDCCH candidates for search space set s for Tₛ consecutive slots, starting from slot n_{s,f}^{μ} and does not monitor PDCCH candidates for search space set s for the next kₛ−Tₛ consecutive slots. The UE determines CCEs for monitoring PDCCH according to a search space set based on a search space equation as described in TS 38.213 v18.1.0 [REF3].

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in TS 38.213 v18.1.0 [REF3] and TS 38.214 v18.1.0 [REF4].

In the following, unless otherwise explicitly noted, providing a parameter value by higher layers includes providing the parameter value by a system information block (SIB), such as a SIB1, or by a common RRC signaling, or by UE-specific RRC signaling.

The following descriptions and embodiments for a UE performing measurements and corresponding measurement reporting equally apply when measurements and reporting by the UE are based on synchronization signal/physical broadcast channel (SS/PBCH) block receptions or CSI-RS receptions.

The following descriptions and embodiments directly apply or are adaptable to terrestrial networks (TN) and non-terrestrial networks (NTN), and functionalities of a satellite and/or of a satellite gateway on earth that is connected to the satellite in NTN can be same as the functionalities of a serving gNB in TN, or can be adapted taking also into account that the satellite footprint of a Low Earth Orbit (LEO) satellite moves over time because of the movement of the satellite respect to the earth. For a Geostationary Earth Orbiting (GEO) satellite, the satellite footprint is fixed, similar to a coverage area of a cell by the gNB in TN.

Throughout this disclosure the terms satellite or serving gNB are used interchangeably to refer to any component (or collection of components) configured to provide remote terminals with wireless access to a network (e.g., the network 130). Descriptions directly apply to satellite network architectures with transparent payload and with non-transparent payload, and to any aerial platforms such as unmanned aerial service (UAS) platforms, as well as to terrestrial networks.

Throughout this disclosure the term beam hopping is generally used to indicate the operation of adapting beams over the satellite footprint in one or more of time/frequency/spatial/power domains, including switching on and off a beam, or using beams with different widths, or using different beams for different control or data channels over a same area or a partially overlapping area.

A non-terrestrial network (NTN) is a network using RF resources on board satellites or unmanned aerial service (UAS) platforms. The NTN includes satellites that can be Geostationary Earth Orbiting (GEO) satellites served by one or several satellite-gateways deployed across the satellites targeted coverage or Low Earth Orbit (LEO) satellites served successively by one or several satellite-gateways at a time, a radio link between a satellite-gateway and the satellite or UAS platform, and a radio link between the UE and the satellite or UAS platform. A satellite or UAS platform may implement either a transparent payload, wherein the NTN payload transparently forwards the radio protocol received from the UE (via the service link) to the NTN Gateway (via the feeder link) and vice-versa, or a regenerative payload with onboard processing. An NTN gateway may serve multiple NTN payloads, and an NTN payload may be served by multiple NTN gateways. The satellite or UAS platform typically generates several beams over a service area or satellite footprint bounded by its field of view. The satellite footprint depends on the onboard antenna diagram and elevation angle. The footprint of a beam or a beam spot can have an elliptic shape and be regarded for some aspects as a cell in terrestrial networks.

Beams over a satellite footprint can be generated by using multi-feed reflector antennas or phased-array antennas at the satellite. GEO satellites are usually equipped with multi-feed reflector antennas, while phased-array antennas are used for LEO satellites because of their wide-angle coverage capabilities. In order to suppress interference, different frequency bands and orthogonal polarizations may be used for the different beams, and reuse of the frequency bands would be among sufficiently isolated beams to guarantee sufficient system capacity. For LEO satellites, the coverage area and the propagation channel characteristics changes due to the fast movement of the satellites, requiring a fast adaptation of resource allocation during connected and non-connected modes. Because of the large satellite footprint, traffic can be unequally distributed within the satellite footprint, including areas with high traffic and usually large areas with sparse or no traffic. In addition, limited payload power and feeder link bandwidth may limit the number of satellite beams that can be active simultaneously with a nominal equivalent isotropic radiated power (EIRP) density per beam at any given time. Such constraints demand solutions that minimize energy consumption and avoid or at least minimize interference between transmissions or receptions in different beams. Thus, it is necessary to flexibly control resources in the multiple beams of a satellite footprint in time, frequency, space or power domain to optimize performance while maintaining coverage.

Similar issues and need for solutions described herein for NTN directly apply to TN, wherein a serving gNB can operate with several beams for transmissions and receptions within a cell. The cell, differently than the NTN case or any aerial platform, does not move as the serving gNB is in a fixed position, however the traffic situation changes over time with some UEs requiring access and/or service and some other UEs transitioning from RRC_CONNECTED state to RRC_IDLE or RRC_INACTIVE state. Mobility of UEs or other types of terminals changes the traffic within the cell, thus there is a need to adapt the network operation within the cell in order to provide the required services while optimizing network energy saving and UE power consumption. Thus, embodiments of the present disclosure recognize that it is necessary to flexibly control resources within the cell in time, frequency, space or power domain to optimize performance, minimize energy consumption for the network and the UEs while maintaining coverage.

One technique that is widely used for controlling a transmission power of a satellite or of a network unit, transmissions and receptions for a time interval, antenna direction, or frequency band, is often referred to as beam hopping to generally indicate adaptation of a beam over a coverage area, including switching on and off beams over time over different areas or varying the transmit power of beams. Beam hopping can provide an efficient allocation of resources based on dynamic traffic needs within a satellite footprint.

FIG. 10 illustrates a diagram of example satellite footprints 1000 according to embodiments of the present disclosure. For example, satellite footprints 1000 can serve any of the UEs 111-116 of FIG. 1. This example is for illustration only and other embodiments can be used without departing from the scope of the present disclosure.

With reference to FIG. 10, within the satellite footprint there can be a number of cells or spots, and each beam provided by a given non-terrestrial networks (NTN)-payload can cover one cell or spot. The satellite 1010 uses a number of beams over the satellite footprint 1020 to serve users in corresponding number of cells for a given time period. For example, the satellite footprint can include a number N of cells or spots, and the satellite at any given time activates a number M of beams, with M<N, or activates N beams. When the traffic over the satellite footprint is expected to be approximately equally distributed, or when there is a need to provide a same level of coverage in the satellite footprint, the satellite can use beams of approximately same beam width and transmit with approximately the same power on each beam over the satellite footprint. When there is no traffic in a given area of the satellite footprint served by a beam, the satellite can switch off the beam 1030. The satellite can use a beam with a first beam width 1040, and over time, adapt the beam width to provide coverage over a larger area with a second beam width 1050. The satellite can use a same beam width to transmit in a certain direction, and adapt the transmit power to provide coverage over a smaller or larger area. The satellite can adapt the beam width to provide coverage over a smaller or larger area, and correspondingly adjust the transmit power. The satellite while transmitting at a maximum power can adapt the beam width to provide coverage over the largest area of the satellite footprint, and/or steers the beam in a different direction.

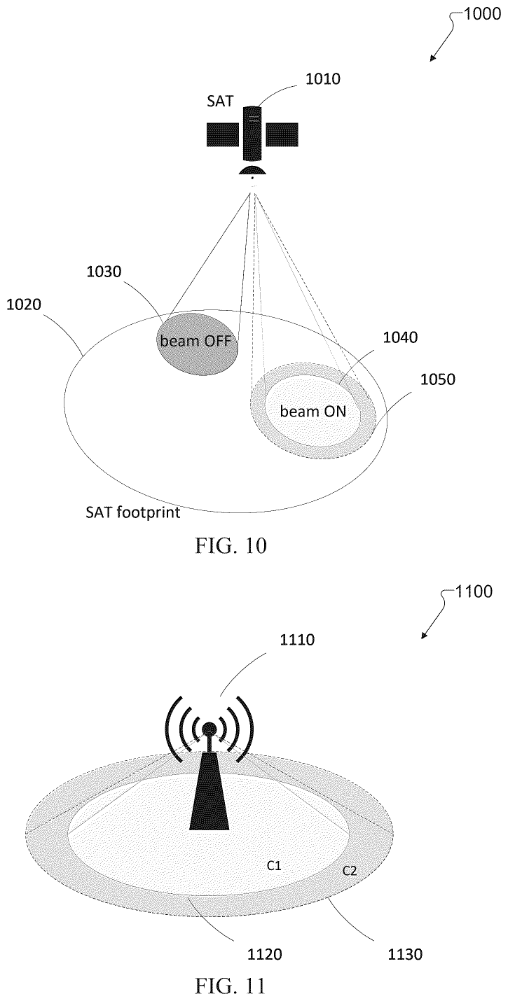

FIG. 11 illustrates an example system 1100 for cell coverages according to embodiments of the present disclosure according to embodiments of the present disclosure. For example, system 1100 for cell coverage can serve any of the UEs 111-116 of FIG. 1. This example is for illustration only and other embodiments can be used without departing from the scope of the present disclosure.

For a TN, with reference to FIG. 11, a serving gNB 1110 can provide coverage over a cell C1 1120 or over a cell C2 1130 varying a transmit power and using a same beam. Based on the traffic needs, the serving gNB can adapt the transmit power while using a same beam, or adapt the beam using a same power, for example when the serving gNB is already transmitting at maximum power. In addition, or alternatively to adapting the power or beam width, the gNB can also adapt the beam direction based on the traffic needs.

Present networks have limited capability for a serving gNB or satellite to dynamically adapt a transmit power of a beam that provides coverage over a cell or over a satellite footprint, or a portion of the cell or satellite footprint. The serving gNB sets the transmit power to provide coverage over the cell, and maintains a same power even when the traffic conditions may change. For a satellite that operates with multiple beams to cover the satellite footprint, the transmit power used in each beam is set to provide coverage for the corresponding area within the satellite footprint, and the same power is maintained while the beam is active.

Therefore, a capability of a serving gNB or a satellite to dynamically adapt a transmit power for transmissions in a beam to the traffic types and load, for example by decreasing the power in low load situations or by increasing the power to provide better coverage for cell edge users or better reception for services that require a higher reliability, would be beneficial for energy saving purposes and/or for improving coverage and capacity.

A serving gNB provides coverage over a cell and transmits DL signals and channels using a beam with a given beam width and beam direction. In the cell there are transmissions or receptions by a serving gNB that may be expected by UEs, such as transmissions of SS/PBCH blocks (SSBs) or of system information or of CSI-RS indicated by higher layers, or receptions of physical random access channel (PRACH) or sounding reference signal (SRS) indicated by higher layers. The serving gNB uses a transmit power for transmissions over the cell using the beam. Depending on the traffic conditions and/or on the network operation mode, the serving gNB can change the transmit power and the cell area changes accordingly. The serving gNB can use a maximum transmit power and provide coverage over a largest cell with the beam, or switch the transmit power off and provide no coverage with the beam.

For example, using the same beam the serving gNB transmits with a first transmit power during a first time interval and with a second transmit power during a second time interval, and the second power is smaller than the first power. The coverage area decreases during the second time interval, and the first cell active during the first time interval is larger than the second cell active during the second time interval. For TN or GEO satellites, the cell becomes smaller during the second time interval and the cell center remains the same as the position of the serving gNB or of the GEO satellite is fixed. UEs located in areas at the edge of cell would be in-coverage when the serving gNB uses the first transmit power, and would be out-of-coverage when the serving gNB uses the second transmit power thus experiencing a degradation of the receptions or not being able to receive signals reliably or receive any signal. For LEO satellites, the coverage area provided by the beam changes overtime due to the relative movement of the satellite and the earth, and areas of the satellite footprint that are in-coverage in a first time instance would be out-of-coverage in a second time instance as the satellite moves away, and the transition from in-coverage to out-of-coverage would happen continuously on a time scale that depends on the satellite speed.

A UE can periodically monitor the signal quality of the DL, for example the UE performs RSRP measurements based on an available DL signal or channel over the cell, such as receptions of synchronization signal/physical broadcast channel (SS/PBCH) blocks or CSI-RS. A measured RSRP is compared to an RSRP threshold provided by the serving gNB in a higher layer parameter, wherein the RSRP threshold can be provided by a cell-specific parameter or by a UE-specific parameter. The cell-specific parameter can be provided when the traffic type in the cell is homogenous, otherwise the serving gNB provides a UE-specific RSRP threshold corresponding to the type of traffic, and a larger value of the RSRP threshold is configured for high reliability traffic and a smaller value is configured for traffic with less stringent reliability requirements. Different values of the RSRP threshold can be configured for different UE types or UE capabilities and depending on whether the UE type or UE capability is known to the serving gNB when the UE is in RRC_IDLE state or in RRC_CONNECTED state, the RSRP threshold can be configured as UE-specific or UE-group-specific parameter by higher layers. The serving gNB provides a first cell-specific RSRP threshold for RSRP measurements in RRC_IDLE state and a second UE-specific or UE-group-specific RSRP threshold for RSRP measurements in RRC_CONNECTED state.

The UE can be provided a first configuration of SS/PBCH blocks and a second configuration of SS/PBCH blocks, wherein SS/PBCH blocks of the first configuration are transmitted over a first area using a first beam and SS/PBCH blocks of the second configuration are transmitted over a second area using a second beam. For example, the first area is C1, and the second area is C2 adjacent to C1, as illustrated in FIG. 11. The serving gNB transmits using a first transmit power using the first beam, and the corresponding coverage area is C1+C2, over which UEs receive SS/PBCH blocks of the first configuration. When the transmit power of the serving gNB changes, and the serving gNB transmits with a second power that is smaller than the first power, using the first beam, the corresponding coverage area is C1 and UEs in C2 would be in out-of-coverage. UEs in C2 would receive SS/PBCH blocks from the second SS/PBCH block configuration and can perform RSRP measurements of SS/PBCH blocks from the second configuration while in out-of-coverage according to the measured RSRP based on SS/PBCH blocks of the first configuration being below the RSRP threshold. When in out-of-coverage in C2, the UE (e.g., the UE 116) may not be able to receive the SS/PBCH blocks. The area over which the serving gNB or satellite transmits SS/PBCH blocks of the second configuration using a corresponding beam or multiple beams, depends on the network (e.g., the network 130) operation.

In one example, the serving gNB transmits SS/PBCH blocks of the second configuration using a corresponding beam in C2 when the serving gNB decreases its transmit power using the first beam from the first transmit power that would provide coverage for C1+C2 to the second transmit power that would provide coverage over C1 only.

In one example, the satellite transmits SS/PBCH blocks of the second configuration using a corresponding second beam over the entire satellite footprint 1020 of FIG. 10 and a second transmit power and transmits SS/PBCH blocks of the first configuration using a corresponding first beam over an area within the satellite footprint 1040 of FIG. 10 and a first transmit power.

First and second SS/PBCH configurations may have different periodicity of the SS/PBCH blocks. For example, first and second coverage areas, wherein first and second coverage areas can be C1 and C2 in FIG. 11, or can be the satellite footprint and the area with the beam ON in FIG. 10, respectively) can be respectively associated with first and second values of a parameter ssb-PeriodicityServingCell that indicates a transmission periodicity in milliseconds for SS/PBCH blocks, or with first and second values of a parameter ssb-PositionsInBurst that indicates time domain positions of SS/PBCH blocks in a SS/PBCH block transmission burst, or with first and second values of a parameter groupPresence that indicates groups of SS/PBCH blocks, such as groups of four SS/PBCH blocks, or of a number of SS/PBCH blocks, with consecutive indexes, that are transmitted.

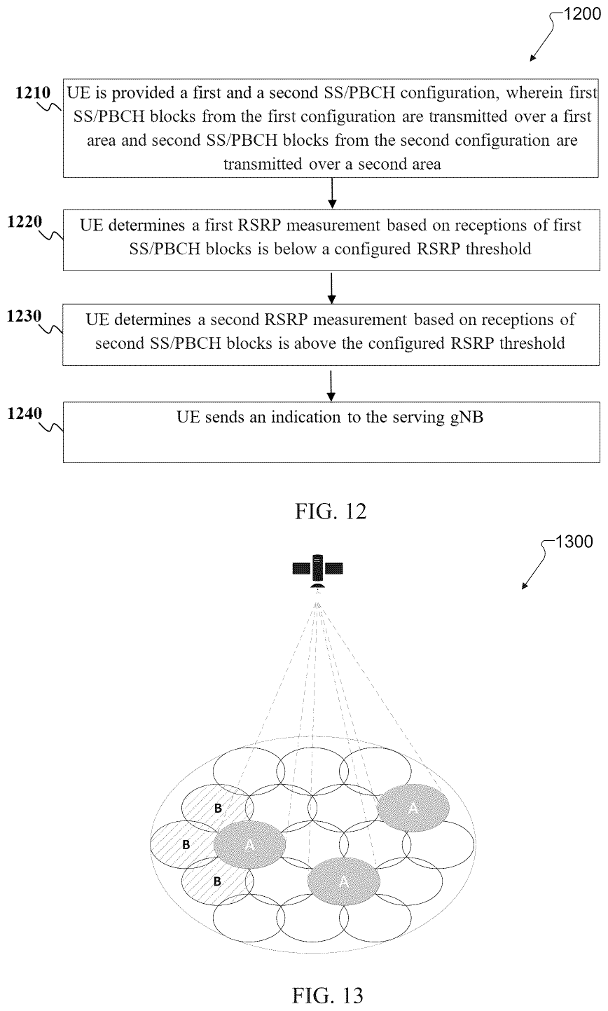

FIG. 12 illustrates a flowchart of an example UE procedure 1200 for transitioning to a low power consumption state and performing RSRP measurements according to embodiments of the present disclosure. For example, procedure 1200 for transitioning to a low power consumption state and performing RSRP measurements can be performed by any of the UEs 111-116 of FIG. 1, such as the UE 116. This example is for illustration only and other embodiments can be used without departing from the scope of the present disclosure.

The procedure begins in 1210, a UE is provided a first and a second SS/PBCH configuration, wherein first SS/PBCH blocks from the first configuration are transmitted over a first area and second SS/PBCH blocks from the second configuration are transmitted over a second area. In 1220, the UE determines a first RSRP measurement based on receptions of first SS/PBCH blocks is below a configured RSRP threshold. In 1230, the UE determines a second RSRP measurement based on receptions of second SS/PBCH blocks is above the configured RSRP threshold. In 1240, the UE sends an indication to the serving gNB.

The serving gNB (e.g., the gNB 102) provides more than two SS/PBCH configurations and the UE would be able to receive SS/PBCH blocks of one or more SS/PBCH configuration in separate areas or in areas that may partially or completely overlap.

For NTN, in a first example, a UE can be provided with a first and a second SS/PBCH block configuration by a satellite, wherein SS/PBCH blocks from the first configuration are transmitted using a first beam that covers a first area within the satellite footprint, wherein the first area can be a portion of the satellite footprint with a higher density of UEs respect to the rest of the satellite footprint, and the SS/PBCH blocks from the second configuration are transmitted using a wider beam than the first beam that covers a second area of the satellite footprint The second area may include (partially or entirely) the first area or may not overlap with the first area. The second area is same as the satellite footprint, in order to provide coverage over the entire satellite footprint for some scenarios. Although transmitting SS/PBCH blocks over the satellite footprint has an impact on the energy consumption, the second configuration can have a much larger periodicity than the periodicity of the first configuration so that the energy consumption is minimized.

With reference to FIG. 12, an example procedure is shown for a UE to transition to a low power consumption state and to perform RSRP measurements based on SS/PBCH block receptions according to the disclosure.

In the following, unless otherwise explicitly noted, providing a parameter value by higher layers includes providing the parameter value by a system information block (SIB), such as a SIB1, or by a common RRC signaling, or by UE-specific RRC signaling.

The following descriptions and embodiments for a UE performing measurements and corresponding measurement reporting equally apply when measurements and reporting by the UE are based on SS/PBCH block receptions or CSI-RS receptions.

The following descriptions and embodiments directly apply or are adaptable to terrestrial networks (TN) and non-terrestrial networks (NTN), and functionalities of a satellite and/or of a satellite gateway on earth that is connected to the satellite in NTN can be same as the functionalities of a serving gNB in TN, or can be adapted taking also into account that the satellite footprint of a Low Earth Orbit (LEO) satellite moves over time because of the movement of the satellite respect to the earth. For a Geostationary Earth Orbiting (GEO) satellite, the satellite footprint is fixed, similar to a coverage area of a cell by the gNB in TN.

Throughout this disclosure the terms satellite or serving gNB are used interchangeably to refer to any component (or collection of components) configured to provide remote terminals with wireless access to a network. Descriptions directly apply to satellite network architectures with transparent payload and with non-transparent payload, and to any aerial platforms such as unmanned aerial service (UAS) platforms.

Throughout this disclosure the term beam hopping is generally used to indicate the operation of adapting beams over the satellite footprint in one or more of time/frequency/spatial/power domains, including switching on and off a beam, or using beams with different widths, or using different beams for different control or data channels over a same area or a partially overlapping area. A beam is defined based on a spatial relation for quasi co-location (QCL) properties of a source reference signal (RS) transmission, such as an SS/PBCH block or a CSI-RS, or by a transmission configuration indicator (TCI) state that establishes a QCL relation or spatial relation between a source reference signal, such as a synchronization signal block (SSB) and/or CSI-RS, and a target reference signal. The TCI state and/or the spatial relation reference RS can determine a spatial Rx filter for receptions by the UE, or a spatial Tx filter for transmissions from the UE. The TCI state and/or the spatial relation reference RS can determine a spatial Tx filter for transmissions from the gNB, or a spatial Rx filter for receptions by the gNB.

Similar issues and need for solutions described above for NTN directly apply to TN, wherein a serving gNB can operate with several beams for transmissions and receptions within a cell. The cell, differently than the NTN case or any aerial platform, does not move as the serving gNB is in a fixed position, however the traffic situation changes over time with some UEs requiring access and/or service and some other UEs transitioning from RRC_CONNECTED state to RRC_IDLE or RRC_INACTIVE state. Mobility of UEs or other types of terminals changes the traffic within the cell, thus there is a need to adapt the network operation within cell in order to provide the required services while optimizing network energy savings and UE power consumption. Thus, it is necessary to flexibly control resources within the cell in time, frequency, space or power domain to optimize performance, minimize energy consumption for the network and the UEs while maintaining coverage.

FIG. 13 illustrates a diagram of example satellite footprints 1300 according to embodiments of the present disclosure. For example, satellite footprints 1300 can serve the UE 116 of FIG. 3. This example is for illustration only and other embodiments can be used without departing from the scope of the present disclosure.

One technique that is widely used for controlling transmission power or transmission/reception time interval, as well as antenna direction or frequency band, is beam hopping. Beam hopping can provide an efficient allocation of resources based on dynamic traffic needs within a satellite footprint. With reference to FIG. 13, within the satellite footprint there can be a number of cells or spots, and a beam provided by a given NTN-payload can cover one cell or spot. The satellite uses a number of beams over the satellite footprint to serve users in corresponding cells for a given time period. For example, the satellite footprint can include a number N of cells or spots, and the satellite at any given time activates a number M of beams, with M<N, or activates N beams. When the traffic over the satellite footprint is expected to be approximately equal distributed or there is a need to provide a same level of coverage in the satellite footprint, the satellite can use beams of approximately same width over the whole footprint. With reference to FIG. 13, the satellite uses beams of same width over the satellite footprint, and over time, the satellite changes the cells that are served by activating different beams in corresponding different areas of the satellite footprint at different time instances, and beams can hop from one cell to another cell within the satellite footprint. For example, in a first time period the satellite activates simultaneously beams that provide coverage for A cells, and in a second time period the satellite activates simultaneously beams that provide coverage for B cells. The satellite may use beams with different beam widths over different areas of the satellite footprint, thus creating cells with different cell footprints. The satellite may also use different beam widths for transmitting SS/PBCH blocks or non-UE specific signaling, and for transmitting UE specific signaling. The satellite may also use different beam widths for initial access procedure and for connected mode transmissions and receptions. For example, the UE may transmit SS/PBCH blocks using a first beam that covers an area that is served by multiple second beams with narrower same or different beam widths than the first beam for operation in connected mode. Thus, the satellite can flexibly allocate beam resources in different areas of the satellite footprint and change the distribution of the capacity in different beams over the satellite footprint. Adaptation of the beams within the satellite footprint is subject to a total transmit power of the satellite, and the beam hopping technique is often referred as power sharing. The total transmit power of the satellite depends on a type of satellite and on a configuration that may allow different settings in one or more of time/frequency/spatial domains.

Throughout this disclosure the term beam hopping is generally used to indicate the operation of adapting beams over the satellite footprint in one or more of time/frequency/spatial/power domains, including switching on and off a beam, or activating beams with different widths, or activating different beams for operation during random access and for connected mode, or activating different beams for different signals or channels, e.g., control or data signals or channels, over a same area or over partially overlapping areas or over non-overlapping areas of the satellite footprint.

Before connecting to an NTN cell, a UE should have valid global navigation satellite system (GNSS) position, as well as have received valid ephemeris and Common TA parameters broadcasted by the network (e.g., the network 130) for the serving cell. To achieve synchronization, before and during connection to an NTN cell, the UE determines the round-trip time (RTT) between UE and the RP based on the GNSS position, the ephemeris, and the Common TA parameters, and autonomously pre-compensate the T_{TA} for the RTT between the UE and the RP as illustrated in Figure 16.14.2.1-1 (clause 4.3 of 3GPP TS 38.211 [REF1]). The UE also determines the frequency Doppler shift of the service link, and autonomously pre-compensates for it in the uplink transmissions, by evaluating UE position and the ephemeris. If the UE does not have a valid GNSS position and/or valid ephemeris and Common TA, the UE does not transmit until both are regained. In connected mode, the UE continuously updates the Timing Advance and frequency pre-compensation. The UE can be configured to report Timing Advance during RA procedures or in connected mode. In connected mode, Timing Advance reporting can be event-triggered. Upon network request, the UE reports its coarse UE location information (most significant bits of the GNSS coordinates, ensuring an accuracy in the order of 2 km) to the NG-RAN if available.

The Synchronization Signal and PBCH block (SSB) includes primary and secondary synchronization signals (PSS, SSS), each occupying 1 symbol and 127 subcarriers, and PBCH spanning across 3 OFDM symbols and 240 subcarriers. The time locations of SSBs within a half-frame are determined by Sub-Carrier Spacing (SCS) and the periodicity of the half-frames where SSBs are transmitted is configured by the network. During a half-frame, different SSBs may be transmitted in different spatial directions (i.e. using different beams, spanning the coverage area of a cell). Within the frequency span of a carrier, multiple SSBs can be transmitted. The Physical Cell Identifiers (PCIs) of SSBs transmitted in different frequency locations can be same or different. When an SSB is associated with a Master Information Block (MIB), or with a Remaining Minimum System Information (RMSI) block that is also referred to as first secondary information block (SIB), the SSB is referred to as a Cell-Defining SSB (CD-SSB) and is the SSB the UE uses to determine a physical cell identity (PCI) of a serving cell providing the SSB. A serving cell is associated to a CD-SSB located on the synchronization raster.

A gNB can also configure Non-Cell-Defining SSB (NCD-SSB) to a UE. For example, for a UE in connected mode, the gNB can configure SSB-based RRM measurements on CD-SSBs and/or NCD-SSBs. When in a serving cell both CD-SSBs and NCD-SSBs are configured, a same PCI is associated with the CD-SSBs and NCD-SSBs. The gNB can configure NCD-SSBs for a UE in connected mode for different functionalities, such as radio link monitoring (RLM), bidirectional forwarding detection (BFD), link recovery, RACH occasion (RO) selection, in TCI-states or for any other functionality other than RRM measurements. For a UE in idle or inactive mode, the gNB can configure NCD-SSBs that the UE can use to perform measurements, however, to read SIB the UE needs to use CD-SSBs.

During the initial cell search, a UE acquires/detects an SSB transmitted by a gNB. The gNB can transmit multiple SSBs with different quasi co-location (QCL) properties, also referred to as beams, and the UE typically acquires the SSB associated with the quasi-co-location properties providing one of the largest RSRPs. Then, expecting beam reciprocity for the DL and UL transmissions, the UE can transmit a PRACH according to a spatial setting that is determined from the detected SSB. The gNB can transmit CD-SSBs or can also transmit NCD-SSBs with same or different quasi co-location (QCL) properties as the CD-SSBs. The QCL properties can be same for a CD-SSB and a NCD-SSB with same index; otherwise, the QCL properties can be different.

A satellite would provide coverage over the satellite footprint by transmitting SSBs with different beams. Each beam can correspond to a cell, and the satellite can transmit one or more SSBs on each cell with an associated SSB periodicity P_{CD}. For operation with beam hopping, the beam would be activated and de-activated during different time intervals. The satellite can transmit CD-SSBs with the beam during the time interval that the beam is active. Beam activation and de-activation can happen with a configured periodicity and/or time pattern. Thus, a UE located in the area of the cell would receive SSBs with a periodicity corresponding to the periodicity of the beam activation/de-activation or, equivalently, according to an ON/OFF beam pattern.

The satellite can transmit NCD-SSBs with an associated first periodicity P_{NCD}, and use different beams to transmit the NCD-SSBs. The satellite can transmit consecutive NCD-SSBs cycling over a number of beams that provide coverage over a number of areas of the satellite footprint. A UE in a first area of the satellite footprint would receive the NCD-SSBs with a periodicity that depends on the first periodicity and on the pattern of the transmissions using the different beams. For example, the satellite can transmit consecutive NCD-SSBs cycling over N beams and one NCD SSB per beam so that the UE in the area covered by one of the N beams receives NCD-SSBs with periodicity N·P_{NCD}. If the area covered by the beam corresponds to a cell associated with a PCI, the UE may also receive CD-SSBs to determine a PCI and the satellite would configure both NCD-SSBs and CD-SSBs with corresponding periodicities and transmitted in corresponding beams. The UE may also receive the PCI associated with the beam in a DL channel or signals other than in an SSB, and the satellite would not configure CD-SSBs associated with the beam. If the area covered by the beam does not correspond to a cell associated with a PCI, the satellite may configure only NCD-SSBs or only CD-SSBs with a PCI associated with the multiple beams covering the satellite footprint.

The present disclosure relates to acquiring synchronization based on CD-SSBs, or NCD-SSBs, or a combination of CD-SSBs and NCD-SSBs in non-terrestrial networks. The present disclosure also relates to receiving information to enhance a procedure for acquiring synchronization for beam hopping operation.

In a first approach, a satellite transmits SSBs with different beams Each beam can correspond to a cell, and the satellite can transmit one or more SSBs on each cell with an associated SSB periodicity P_{CD,b}. If multiple SSBs are transmitted within one period, the multiple SSBs are transmitted using a same beam and the UE expects that the SSBs are quasi co-located. The satellite transmits SSBs using a same beam for a number of periods, and then transmits SSBs using another beam for another number of periods.

In one example a UE is provided an SSB configuration that indicates a first number of SSBs periods, or equivalently a first-time interval during which the satellite transmits the SSBs using a same beam before starting the transmission of SSBs with another beam. The SSB configuration can also indicate a second number of SSBs periods, or equivalently a second time interval during which the satellite transmits SSBs with a different beam. A transmission pattern of SSBs in a cell can be also configured separately by a higher layer parameter.

Without a loss of generality, for operation with beam hopping with two beams and corresponding two cells, a first beam would be activated and de-activated in subsequent time intervals, and the UE in a first cell associated with the first beam receives SSBs with periodicity P_{CD,b1} only during the active time intervals for the first cell. During the inactive time intervals for the first cell associated with the first beam, the satellite transmits SSBs using a second beam in a corresponding second cell, and a UE in the second cell receives SSBs with periodicity P_{CD,b2} only during the active time intervals for the second cell. Periodicities of SSBs associated with the different beams can be the same, e.g., P_{CD,b1} and P_{CD,b2} have the same value P_{CD,b} and the satellite would transmit SSBs with periodicity P_{CD,b} using different beams in different time intervals.

During the time interval the satellite transmits SSBs using the first beam, these SSBs include information for a first PCI of the first cell and are used by the UE to determine the PCI of the first cell. Similarly, during a second time interval the satellite transmits SSBs using the second beam, these SSBs include information for a second PCI of the second cell and are used by the UE to determine the PCI of the second cell.

In one example, for operation with beam hopping a UE is provided information of a time interval over which the satellite transmits SSBs using a first beam and of a time interval over which the satellite transmits SSBs using beams different than the first beam. The UE acquires the SSBs associated with the quasi-co-location property according to a configured periodicity P_{CD,b} during the time interval over which the satellite transmits SSBs using a first beam and does not attempt to detect SSBs during the time interval that SSBs are transmitted using beams different than the first beam.

In one example, for operation with beam hopping a UE would attempt to receive SSBs associated with the quasi-co-location property according to a configured periodicity P_{CD,b}, and discard receptions with a low RSRP.

For operation with beam hopping, due to an unavailability of SSBs associated with a same QCL property, or same beam, according to a configured periodicity P_{CD,b} a UE in a cell of the satellite footprint may experience a large latency in accessing the network and successfully complete an initial random-access procedure. In order to reduce the latency in accessing the network, a UE can be provided information associated to frequencies of SSBs that are transmitted using with same QCL property, or same beam, on frequencies corresponding to a channel raster.

In a first approach for performing measurements on a cell, such as for synchronization or RSRP, the cell can be associated to SSBs with a certain periodicity, and the frequency of the SSBs is provided by absoluteFrequencySSB as described in REF 5, and the SSBs are on the synchronization raster. The frequency domain offset between SSB and the overall resource block grid in number of subcarriers is provided in ssb-SubcarrierOffset, and absence of the field indicates that no offset is applied. The list of one or multiple frequency bands to which the carrier(s) belongs is provided in frequencyBandList, and multiple values can be provided in system information. An absolute frequency position of the reference RB is provided in absoluteFrequencyPointA corresponding to the lowest subcarrier that is defined in the scs-SpecificCarrierList. The offset in frequency domain between Point A (lowest subcarrier of common RB 0) and the lowest usable subcarrier on this carrier in number of PRBs (using the subcarrierSpacing defined for this carrier) is provided in offsetToCarrier.

In a second approach for performing measurements on a cell, such as for synchronization or RSRP, the cell transmits NCD-SSBs that UEs within the satellite footprint may use to access the network. Depending on the availability of NCD-SSBs and/or CD-SSBs and configurations of NCD-SSBs and CD-SSBs in time/frequency/space domains, the UE (e.g., the UE 116) may acquire synchronization or perform measurements for RSRP using only NCD-SSBs, or only CD-SSBs, or both, subject to a UE capability. It is feasible that the initial access procedure is a two-step approach wherein the UE uses CD-SSBs in a second step to acquire the PCI. It is also feasible that the UE receives the PCI information via a different signaling than CD-SSBs.

A cell can be associated to one or more NCD-SSBs of a certain periodicity, which can be indicated to a UE by higher layers and may or may not be located on the channel raster associated to a CD-SSB. For example, for a cell associated to a CD-SSB and an NCD-SSB, the frequency of the CD-SSB is provided by absolute FrequencySSB as described in REF 5, and the frequency of the NCD-SSB can be same or different than the frequency of the CD-SSB. When different, the frequency of NCD-SSB needs also to be provided by a corresponding absolute FrequencySSB. The time location of CD-SSBs and NCD-SSBs can be same or different. For example, a UE can be indicated by higher layers a time location for an NCD-SSB independently or relative to a time location of a CD-SSB. The transmission power of CD-SSB and NCD-SSB can be same or different and can depend on whether they are both associated to a same serving cell. For example, when CD-SSB and NCD-SSB are associated to a same cell they have the same transmission power. A serving cell can be associated with a CD-SSB and one or more NCD-SSBs. Alternatively, one or more of the NCD-SSBs can be associated with a non-serving cell.

For NCD-SSBs, the frequency of the NCD-SSB is provided in absolute FrequencySSB and the periodicity of the NCD-SSB is provided in ssb-Periodicity. The network can configure periodicities that are larger than the periodicity of a serving cell's CD-SSB or can configure periodicities that are smaller than the periodicity of a serving cell's CD-SSB. If the field is absent, a UE applies the SSB periodicity of the CD-SSB. The network can configure periodicities of NCD-SSB associated with time intervals, and during a first-time interval NCD-SSBs are transmitted with a first periodicity and during a second time interval NCD-SSBs are transmitted with a second periodicity, and so on. More than two periodicities can be defined. A change of the periodicity of the NCD-SSBs can be periodic and/or defined according to a configured time pattern or can be indicated by higher layers. For transmissions of NCD-SSBs on different frequencies, NCD-SSB periodicities (and time pattern, if any) can be configured with same or different values on different frequencies. It is also feasible that the periodicity of the CD-SSB is configured relative to the periodicity of the NCD-SSBs. The network can configure periodicities for a serving cell's CD-SSB that are larger than the periodicity of NCD-SSB or can configure periodicities for a serving cell's CD-SSB that are smaller than the periodicity of NCD-SSB. If the field is absent, a UE applies the SSB periodicity of the NCD-SSB.

For NCD-SSBs, the time offset between CD-SSB of the serving cell and this NCD-SSB is provided in ssb-TimeOffset. For example, a value of 5 ms means the first burst of NCD-SSB is transmitted 5 ms later than the first burst of CD-SSB transmitted after the first symbol of system frame number (SFN)=0 of the serving cell, value 10 ms means the first burst of NCD-SSB is transmitted 10 ms later than the first burst of CD-SSB transmitted after the first symbol in SFN=0 of the serving cell, and so on. If the field is absent, the UE considers that the time offset between the first burst of CD-SSB transmitted in the serving cell and the first burst of this NCD-SSB transmitted is zero. It is also feasible that the time offset of CD-SSBs is configured relative to NCD-SSBs.

In a third approach for performing measurements on a cell, such as for synchronization or RSRP, the cell transmits NCD-SSBs that UEs within the cell footprint uses to access the network and a PCI is not provided to the UE.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to perform a measurement on a cell, the method comprising:
receiving first information for first parameters of a first synchronization signal on the cell;
receiving second information for second parameters of a second synchronization signal on the cell;
receiving the first and second synchronization signals on the cell, wherein the first and second synchronization signals have same quasi co-collocation properties; and
determining, based on the first and second synchronization signals, the measurement on the cell.

2. The method of claim 1, wherein:
the first synchronization signal is a first synchronization signal and physical broadcast channel (SS/PBCH) block,
the second synchronization signal is a second SS/PBCH block,
the first SS/PBCH block is a cell-defining SS/PBCH block for the cell, and
the second SS/PBCH block is not a cell-defining SS/PBCH block for the cell.

3. The method of claim 1, wherein:
the first parameters include a first periodicity for the first synchronization signal on the cell, and
the second parameters include a second periodicity for the second synchronization signal on the cell.

4. The method of claim 1, wherein:
the first parameters include a first power for the first synchronization signal on the cell, and
the second parameters include a second power for the second synchronization signal on the cell.

5. The method of claim 1, wherein:
the first synchronization signal is associated with a first index,
the second synchronization signal is associated with a second index, and
the first index and the second index have a same value.

6. The method of claim 1, wherein:
the first parameters include a time duration,
the reception of the first synchronization signal is only within the time duration, and
the time duration repeats periodically.

7. The method of claim 1, wherein the measurement is for synchronization in time or frequency.

8. A user equipment (UE) comprising:
a transceiver configured to receive:
first information for first parameters of a first synchronization signal on a cell,
second information for second parameters of a second synchronization signal on the cell, and
the first and second synchronization signals on the cell, wherein the first and second synchronization signals have same quasi co-collocation properties; and
a processor operably coupled to the transceiver, the processor configured to determine, based on the first and second synchronization signals, a measurement on the cell.

9. The UE of claim 8, wherein:
the first synchronization signal is a first synchronization signal and physical broadcast channel (SS/PBCH) block,
the second synchronization signal is a second SS/PBCH block,
the first SS/PBCH block is a cell-defining SS/PBCH block for the cell, and
the second SS/PBCH block is not a cell-defining SS/PBCH block for the cell.

10. The UE of claim 8, wherein:
the first parameters include a first periodicity for the first synchronization signal on the cell, and
the second parameters include a second periodicity for the second synchronization signal on the cell.

11. The UE of claim 8, wherein:
the first parameters include a first power for the first synchronization signal on the cell, and
the second parameters include a second power for the second synchronization signal on the cell.

12. The UE of claim 8, wherein:
the first synchronization signal is associated with a first index,
the second synchronization signal is associated with a second index, and
the first index and the second index have a same value.

13. The UE of claim 8, wherein:
the first parameters include a time duration,
the transceiver is further configured to receive the first synchronization signal only within the time duration, and
the time duration repeats periodically.

14. The UE of claim 8, wherein the measurement is for synchronization in time or frequency.

15. A base station comprising:
a transceiver configured to transmit:
first information for first parameters of a first synchronization signal on a cell,
second information for second parameters of a second synchronization signal on the cell, and
the first and second synchronization signals on the cell, wherein:
the first and second synchronization signals have same quasi co-collocation properties, and
at most one of the first and second synchronization signals is transmitted at any given time instance.

16. The base station of claim 15, wherein:
the first synchronization signal is a first synchronization signal and physical broadcast channel (SS/PBCH) block,
the second synchronization signal is a second SS/PBCH block,
the first SS/PBCH block is a cell-defining SS/PBCH block for the cell, and
the second SS/PBCH block is not a cell-defining SS/PBCH block for the cell.

17. The base station of claim 15, wherein:
the first parameters include a first periodicity for the first synchronization signal on the cell, and
the second parameters include a second periodicity for the second synchronization signal on the cell.

18. The base station of claim 15, wherein:
the first parameters include a first power for the first synchronization signal on the cell, and
the second parameters include a second power for the second synchronization signal on the cell.

19. The base station of claim 15, wherein:
the first synchronization signal is associated with a first index,
the second synchronization signal is associated with a second index, and
the first index and the second index have a same value.

20. The base station of claim 15, wherein:
the first parameters include a time duration,
the transceiver is further configured to transmit the first synchronization signal only within the time duration, and
the time duration repeats periodically.
